(19) United States
(12) Patent Application Publication
(10) Pub. No.: US 2019/0329712 A1
(43) Pub. Date: Oct. 31, 2019

(54) Extendable Roof/ Truck Bed Racks

(71) Applicant: Brad Damon Howell, Long Valley, NJ (US)

(72) Inventor: Brad Damon Howell, Long Valley, NJ (US)

(21) Appl. No.: 16/259,693

(22) Filed: Jan. 28, 2019

Related U.S. Application Data
(60) Provisional application No. 62/624,027, filed on Jan. 30, 2018.

(51) Int. Cl. B60R 3/02; B60R 9/06

(52) U.S. Cl. CPC B60R 3/02; B60R 9/06

(57) ABSTRACT

The purpose of Extendable Roof/Truck Bed Racks is to provide adequate support for carrying long objects or materials on a car or truck. When not in use, or supporting long objects or materials, they can be collapsed or folded in order to take up less space, create less wind noise, and allow for easier storage.

### BRIEF DESCRIPTION OF DRAWINGS

FIG. 1 Shows a top view of the Extendable Racks as designed to fit on top of a vehicle in an extended position.

FIG. 2 Shows a side profile of the Extendable Racks as designed to be part of a truck bed rack and installed on a truck bed.

FIG. 3 Shows a top view of the Extendable Racks installed on a vehicle in a mostly retracted position.

FIG. 4 Shows an adjustable rubber strap type mounting flange designed to secure the Extendable Rack to an existing vehicle roof rack.

FIG. 5 Shows two types of mounting flanges, with through bolt and U bolts for securing the Extendable Racks.

FIG. 6 Shows the use of adjustment holes into which a locking pin would be inserted for adjusting the length of the Extendable Racks.

FIG. 7 Shows the use of telescoping tube adjusters as another option for adjusting the Extendable Racks.

FIG. 8 Shows two types of pins, spring loaded and removable, that could be used for locking the extensions on the Extendable Racks.

FIG. 9 Shows the use of a hinge to extend or fold the extensions on the Extendable racks.

FIG. 10 Shows another view of a hinge type extension for the Extendable Racks.

### BRIEF DESCRIPTION OF INVENTION

The following details describe the parts of the invention and how they work. This is not meant to be limiting, but is intended to illustrate the general purpose of the invention. The scope of the invention is best defined by its claims. Various features of the invention can be used independently, incorporated together, or with other features.

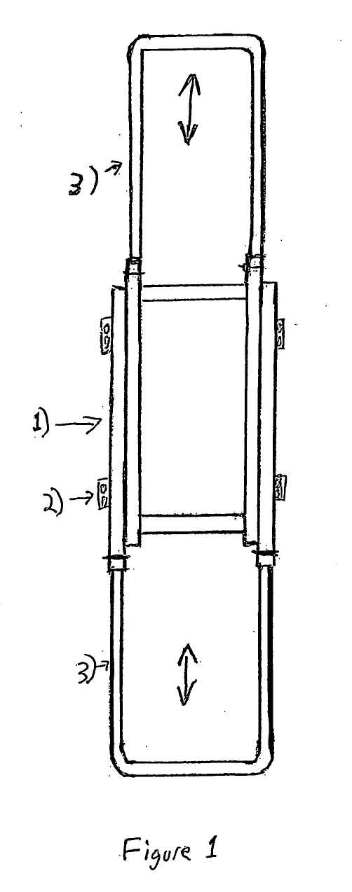

FIG. 1. The extendable racks are shown in the extended position. The arrows indicate the direction of movement for the extendable supports. The racks may have the main body 1) of the extendable racks secured to it with the various types of mounting flanges 2). The fore and aft extendable supports 3) can be extended or retracted with various different types of adjusters.

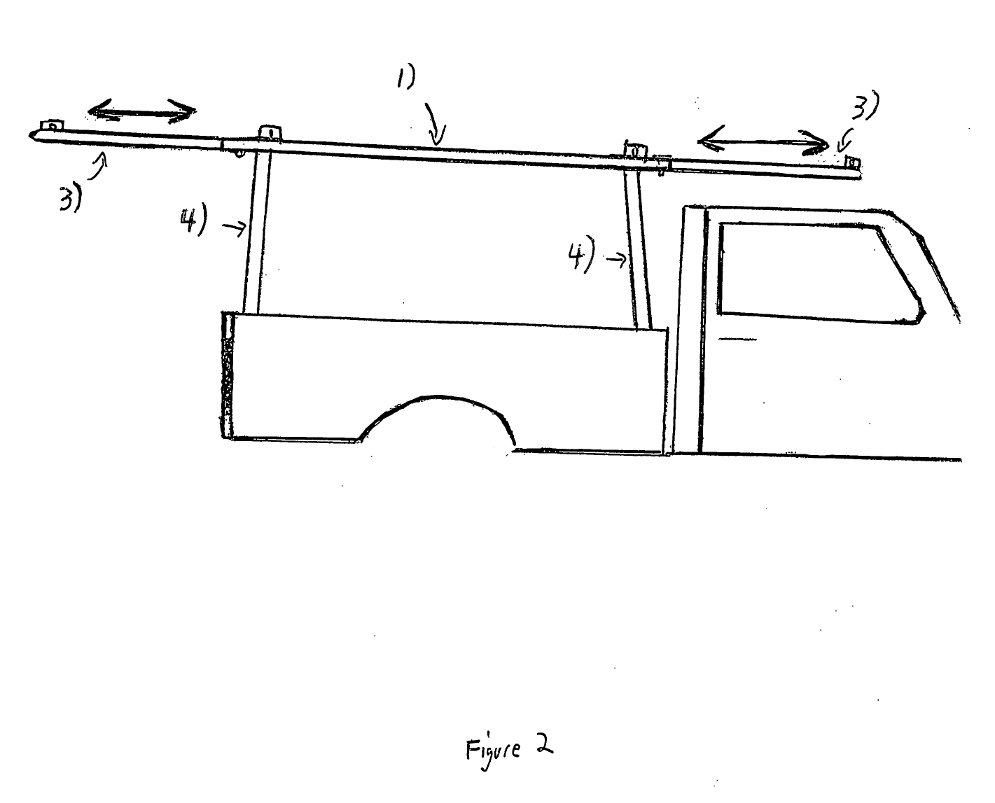

FIG. 2. The extendable racks are incorporated into a truck bed style rack with mounting legs 4) mounted to the top of a pick up truck bed. In this design, the main body of the extendable rack 1) may be the same length as the truck bed, and fore and aft extensions 3) which can be adjusted to the desired length by sliding in and out of the main rack body 1).

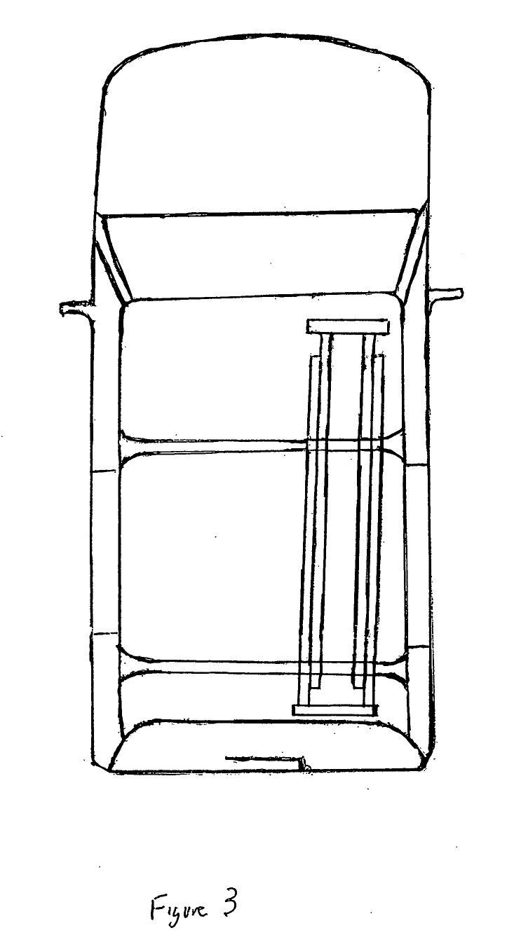

FIG. 3. A top view of the Extendable Racks installed on a vehicle in a mostly retracted position is shown.

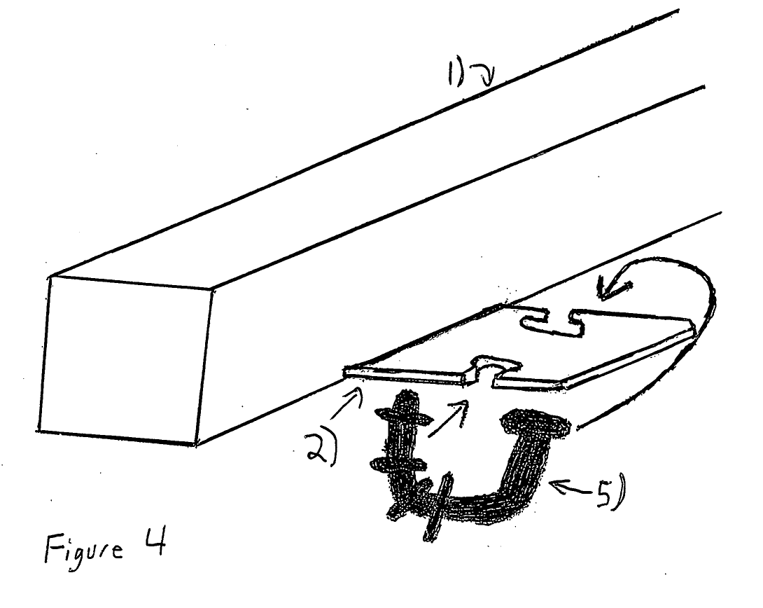

FIG. 4 Illustrates an option of mounting type flange 2) in which rubber straps 5) with incremental flares would wrap around a rack and lock into the flange to secure the main body tubes 1) of the rack into place.

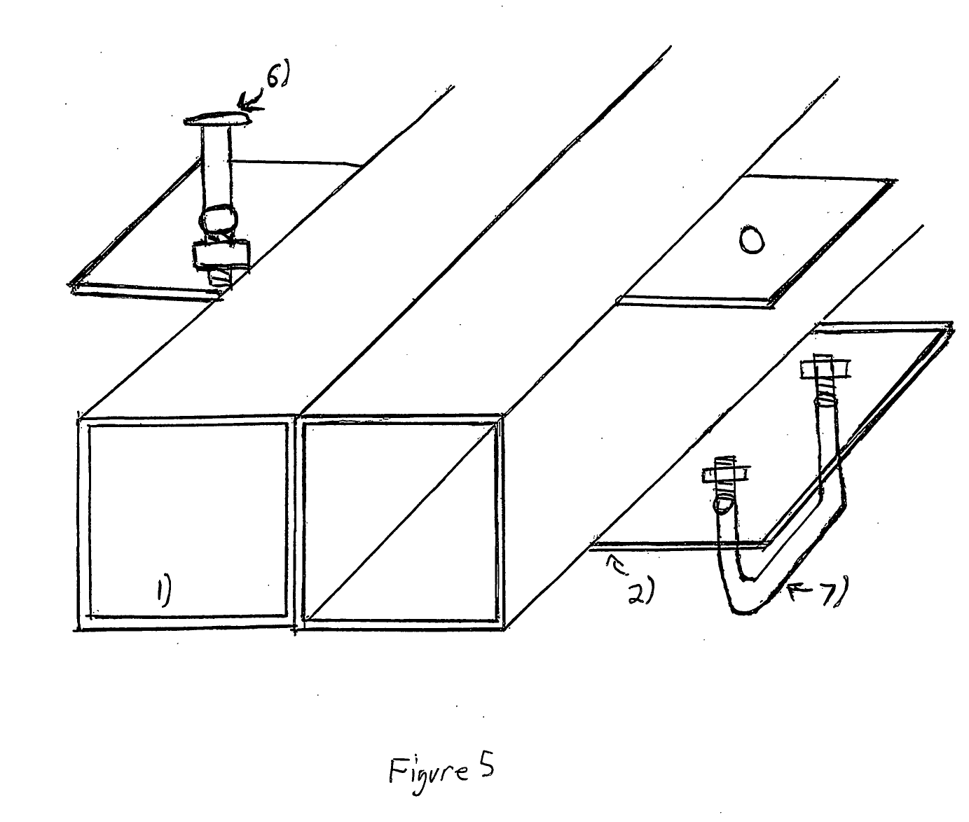

FIG. 5 Illustrates two optional of types of mounting flanges 2) with a through bolt 6) and a U bolt 7) designed to secure the Extendable Rack to an existing truck bed rack or roof rack. Through bolts and flanges 6) can be used to secure the rack from underneath, U bolts 7) can be used to secure the main body 1) of the Extendable Rack from above.

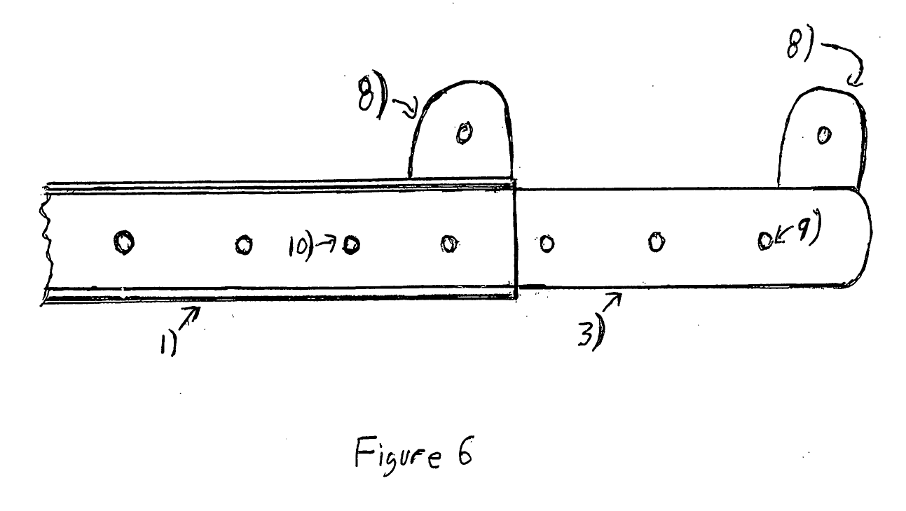

FIG. 6 Illustrates strapping flanges 8) incorporated into the extendable racks to allow material to be secured to the racks. Flanges can be mounted on the main body 1) and the extensions 3).

Also shown in FIG. 6 are optional adjustment holes 9) in the extensions 3) that can be locked into place by aligning with the holes 10) in the main rack body 1) and inserting a locking pin.

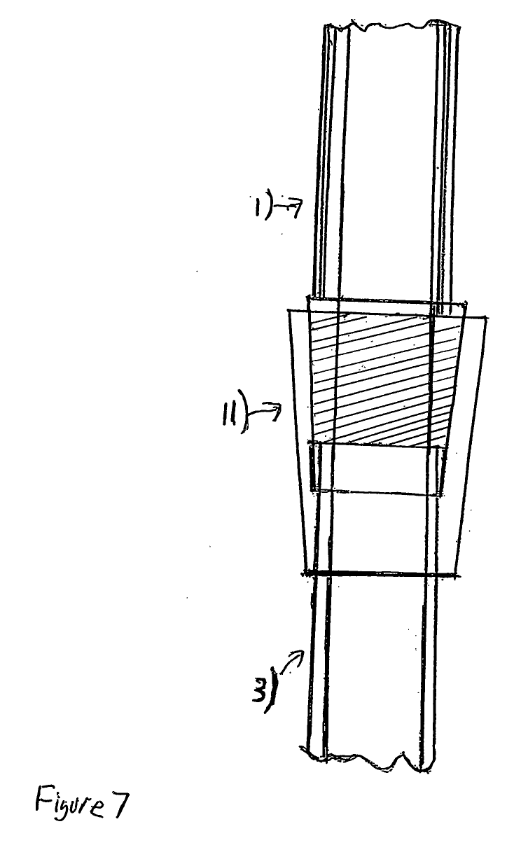

FIG. 7 Illustrates the use of a telescoping tube adjuster 11) secured to the main body tubes 1) that can be tightened to lock the extension tubes 3) into place once adjusted to their desired length.

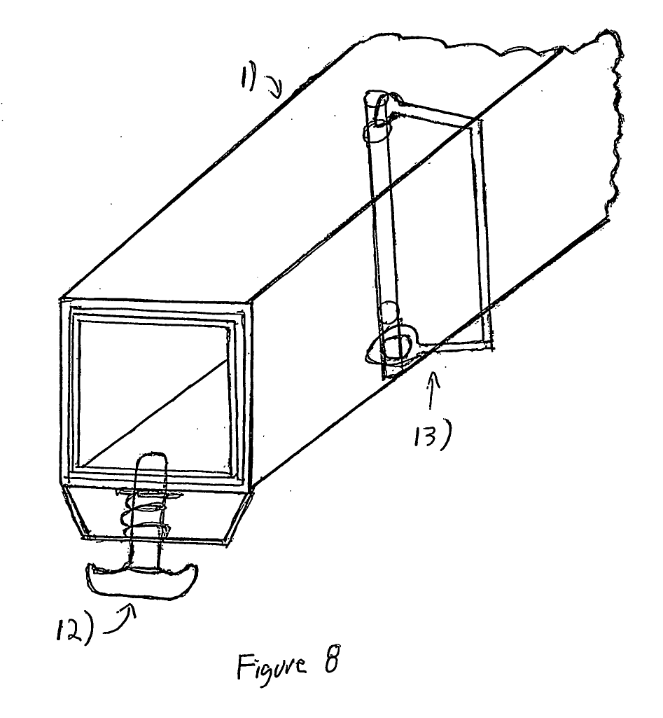

FIG. 8 Illustrates the use of a spring loaded locking pin 12) mounted to the main body tubes 1) could engage the extensions to lock into place, or how a removable locking pin 13) could also be used to lock the tubes together at the desired adjustment points.

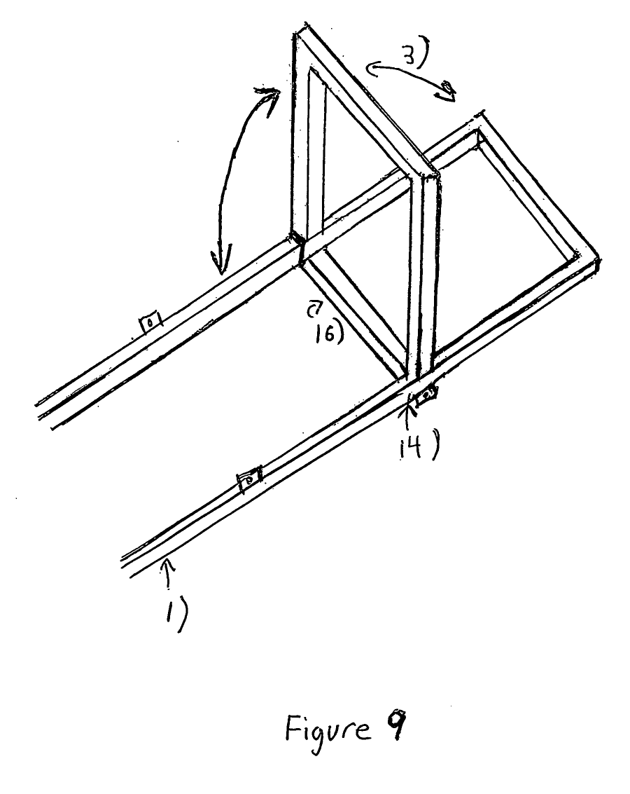

FIG. 9 Illustrates hinges 14) used as the method of extension adjustment. Where as the extensions 3) are secured to the main rack body 1) with hinges. A locking pin can be inserted through flanges 15) mounted on the main rack body and into a hole on the rack extension to prevent the extensions from bouncing. A mid support bar 16) would provide support for materials with the rack in the open or closed positions.

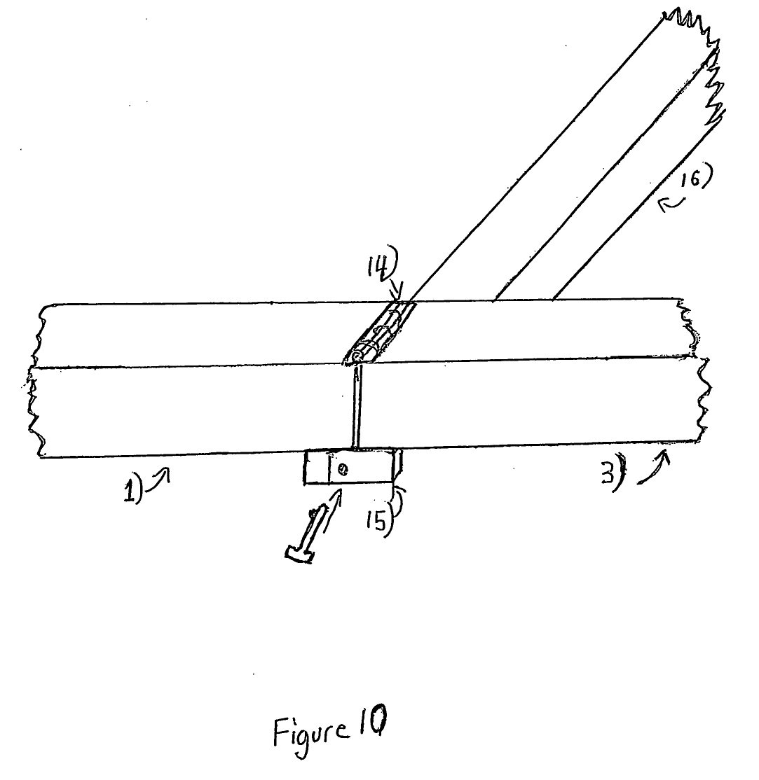

FIG. 10 Illustrates another view a hinge 14) in relation to the main rack 1) and the rack extension 3). The mid support bar 16) could rotate with the extensions so that the top of the rack always has support whether in open or closed positions.

### SUMMARY OF INVENTION

The problem with most roof racks and truck bed racks for cars and trucks is their inability to support long lengths of materials, especially racks for smaller cars and trucks. The adjustable design of these racks allows the user to extend the length of the racks when needed to support materials, and shorten them when not necessary, or in use. This solves the problem of not being able to support and carry long lengths of materials safely on vehicles with small roof or truck bed racks. Additionally, being able to shorten the racks will help decrease wind noise by not having them extend beyond the roof line when not in use. This is a problem often associated with larger truck bed racks that extend over the cab. On cars and SUVs, the extendable racks will also allow the user to open and close their rear tailgate door without hitting the racks when not in use.

If material is not supported adequately, it is likely to break, especially if it is not a sturdy item. Carrying long lengths of material inside of a vehicle and having it project out through a window is unsafe for the occupants of the vehicle, likely to damage the interior of the vehicle, and may result in breakage of the materials.

The Extendable Roof/Ladder rack design can either be incorporated into the design of a truck bed rack system, or added to an existing truck rack or roof top rack for a car or SUV.

A roof or truck bed rack or rack attachment comprising:

1) A roof or truck bed rack or rack attachment comprising a primary extendable support frame with locking mechanisms on each extension, and flanges for securing material, that secures to a truck bed, truck bed rack, or roof rack, with mounting flanges, or is incorporated into the design of a truck bed rack or roof rack system.

2) The extension supports of claim 1, both front and rear, slide into or hinge on the primary support frame.

3) The locking mechanisms of claim 1 are intended to prevent the extensions from moving or falling out once placed into the desired position

4) The mounting flanges referenced in claim 1 can utilize hardware or fasteners such as but bot limited to, through bolts, U bolts, or straps to secure the rack to an existing roof rack, truck rack, or truck bed.

5) The flanges for securing material referenced in claim 1 are not critical to the functionality of the invention, however, if incorporated, they can be placed in many locations on the rack in order to allow for the securing of materials, however they should be located so as they do not to interfere with the adjust-ability of the racks.
